(19) United States
(12) Patent Application Publication
(10) Pub. No.: US 2007/0079343 A1
(43) Pub. Date: Apr. 5, 2007

(54) Information processor and information processing method

(76) Inventors: Satoru Takashimizu, Yokosuka (JP); Satoshi Iimuro, Yokohama (JP); Etsuko Aoki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/482,790

(22) Filed: Jul. 10, 2006

(30) Foreign Application Priority Data
Oct. 5, 2005 (JP) 2005-291899

(51) Int. Cl. H04N 7/16; H04N 5/44; H04N 7/173

(52) U.S. Cl. 725/100; 725/131; 725/139; 725/151; 348/725

(57) ABSTRACT

A digital broadcast receiving/recording/reproducing device records and reproduces input streams in and on a recording/reproducing device, simultaneously records two streams, and reproduces one stream while reproducing the other recorded stream at the same time, thereby the streams can be viewed. The digital broadcast receiving/recording/reproducing device of the present invention extracts a distinctive part of video or audio data to be recorded, processes other video or audio data to be recorded at the same time in association with each other, creates a management file for processing information regarding the associated data, and records the created file together with the video or audio data to be recorded in a recording section. Then, the digital broadcast receiving/recording/reproducing device controls whether to reproduce the recorded video or audio data recorded based on the information of the management file.

### CLAIM OF PRIORITY

The present application claims priority from Japanese application serial no. JP 2005-291899, filed on Oct. 5, 2005, the content of which is hereby incorporated by reference into this application.

### BACKGROUND OF THE INVENTION

The present invention relates to an information processor having an image pickup system.

In recent years, digital broadcast services have been provided. Such services use a BS digital broadcast with a Broadcast Satellite or ground wave. For example, JP-A No. 257956/2001 discloses a conventional technique for simultaneously displaying a broadcast image and an externally input image, by using the feature of the digital broadcast service.

### SUMMARY OF THE INVENTION

The above-mentioned conventional Patent Reference discloses only a technique for simultaneously displaying the broadcast image and the externally input image (image of a family, etc.) and for simply displaying both images on the same display screen. However, the conventional Patent Reference does not specifically disclose a technique for processing both images in association with each other in a predetermined way.

Particularly, the above document mentions a technique for simply displaying program information (e.g. the type of a broadcast program, etc.) added to the broadcast program in association with family image information stored in advance. That is, the Patent Reference does not mention a technique for displaying the broadcast video image itself and an image input from a camera in a manner corresponding to these associated images. Thus, it is difficult to provide a user-friendly service or system for displaying the program image in association with the input image.

It is accordingly an object of the present invention to provide an information processor which can provide a user-friendly system with efficiently using video and audio information.

To accomplish the above object, according to a system, for example, a camera is connected to a TV and photographs a viewer, and information representing the photographed data of the camera is recorded in association with program information of the program watched by the viewer at the time. By “recorded in association with” is meant to process the program watched by the viewer in association with data photographed by the camera. For example, suppose that a child is watching a cartoon program with a happy look. In this case, when reproducing the cartoon program, the program is reproduced with the appearance of the happy child.

For example, when it is instructed to reproduce the appearance image of the happy look, the system can provide information (e.g. the program title, a particular scene of the program) regarding the cartoon program that the child watched with a happy look.

The program includes not only a TV program broadcasted by a broadcasting station, but also a program distributed through the Internet, a short film or a slide show consisting of still images.

In particular, the above-described object can be accomplished by the inventions described in the claims.

According to the above system, there can be provided a user-friendly information processor with the use of the video and audio information.

### BRIEF DESCRIPTION OF THE DRAWINGS

FIG. 1 is a diagram showing one structure of an information processor;

FIG. 2 is a diagram showing an example of an input signal;

FIGS. 3A and 3B are diagrams each showing an example of a processing signal;

FIG. 4 is a diagram exemplarily showing a structure of a recording/reproducing controller;

FIG. 5 is a diagram showing an example of a processing signal;

FIGS. 6A, 6B and 6C are diagrams each exemplarily showing a content structure of a management file;

FIGS. 7A, 7B, 7C, 7D and 7E are diagrams each exemplarily showing a reproduced display screen;

FIG. 8 is a diagram showing a service model with the use of a management file;

FIGS. 9A, 9B, 9C and 9D are diagrams each exemplarily showing a piece of data exchanged in the service model with the use of a management file;

FIGS. 10A, 10B and 10C are diagrams each exemplarily showing a reproduced display screen; and

FIG. 11 is a block diagram showing a structure of an information processor.

### DETAILED DESCRIPTION OF THE PREFERRED EMBODIMENTS

Preferred embodiments of the present invention will now be described with reference to the drawings. In the preferred embodiments, the same structural components are identified with the same symbols.

### First Embodiment

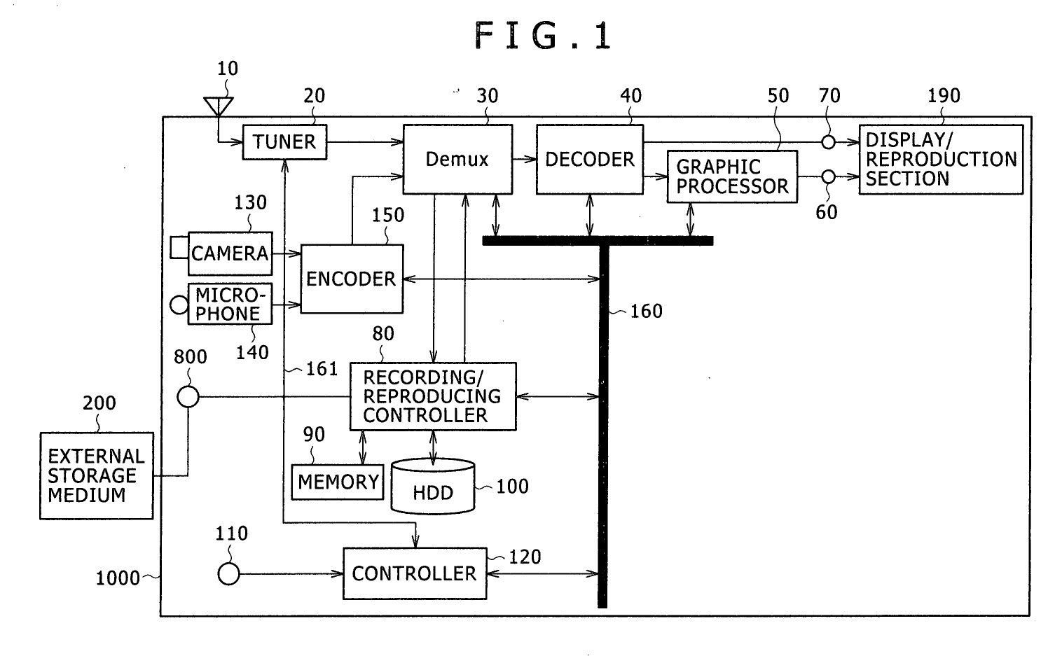

FIG. 1 is a diagram exemplarily showing a structure of a recording/reproducing device which can receive digital broadcast data, in this embodiment. It is assumed below that this recording/reproducing device is a receiving/recording/reproducing device 1000 which can receive digital broadcast data. However, this embodiment is not limited to this device 1000, and it may include any other information processor which can acquire video or audio contents through a network, such as the Internet, etc., instead of a broadcast system. In this embodiment, the following description focuses on a system for processing a signal that has been encoded and multiplexed in the MPEG (Moving Picture Experts Group) format, but the signal is not particularly limited to the MPEG signal.

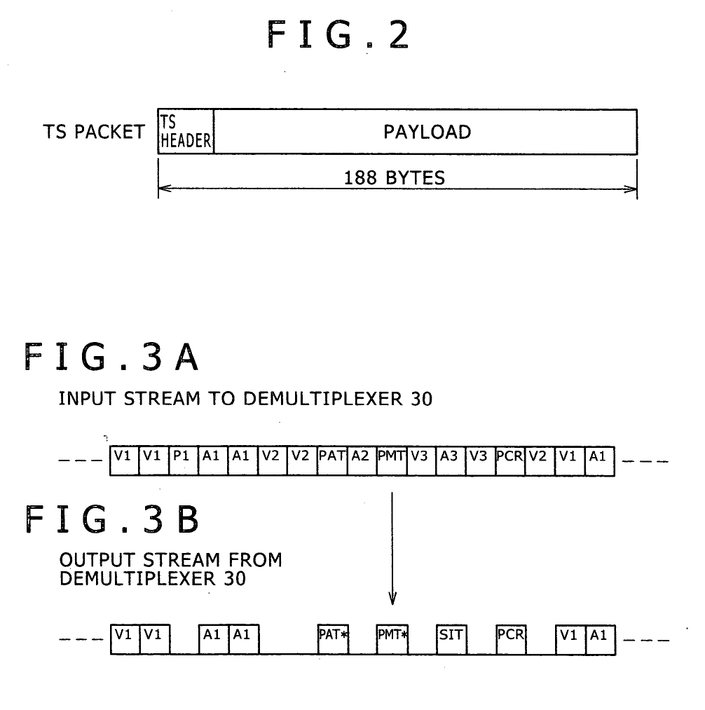

A broadcast receiving antenna 10 receives a radio wave sent from a broadcasting station (not illustrated). A tuner 20 tunes a desired signal from signals supplied from the antenna 10, demodulates the tuned signal and corrects errors of the signal, thereby reproducing a transport stream. In this embodiment, the transport stream contains plural 188-byte packets, for example, as shown in FIG. 2. Invalid data may exist between packets. The reproduced transport stream is provided to a demultiplexer 30. The demultiplexer 30 extracts encoded video data, encoded audio data and other data corresponding to a specified program.

In real-time viewing, the extracted encoded video and audio data are supplied to a decoder 40. The decoder 40 decodes the supplied data so as to output a video signal and an audio signal. The decoded video signal is supplied to a graphic processor 50. The graphic processor 50 outputs the video signal in a form that a graphic display is superimposed thereon if needed. The output video signal of the graphic processor 50 and the output audio signal of the decoder 40 are output respectively from data output sections, such as a video output section 60 and an audio output section 70. The output signals are reproduced by a non-illustrated display reproducer, for example, a TV. Such processes are controlled by a controller 120 which operates in response to an instruction sent from a non-illustrated remote controller using an input section 110.

When recording a specified program in an HDD 100 in accordance with an instruction from the non-illustrated remote controller, the demultiplexer 30 extracts any of those packets corresponding to the specified program, multiplexes a packet (newly created or prepared in advance for reference at the time of reproduction) thereonto and outputs the packet.

FIGS. 3A and 3B exemplarily show examples of an input transport stream and an output transport stream, when the demultiplexer 30 processes the transport stream of the program specified to be recorded.

In FIGS. 3A and 3B, it is assumed that the demultiplexer 30 records the program including video data V1, audio data A1 and time information PCR (Program Clock Reference) specified in P1. Though not illustrated in FIGS. 3A and 3B, if data broadcasting is a component part of the program, a packet corresponding to this data broadcasting is recorded. The demultiplexer 30 temporarily deletes information packets (referred to at the time of reproduction) of a PAT (Program Association Table) and a PMT (Program Map Table), creates and multiplexes a PAT and a PMT, under the control of the controller 120. These PAT and PMT correspond to a stream having program information that is composed of only the multiplexed video data V1, audio data A1 and time information PCR specified in P1. Note that the PAT and the PMT are not necessarily deleted and multiplexed, but may be rewritten in a non-illustrated memory.

Program information including a title of the to-be-recorded program is extracted, and an SIT (Selection Information Table) is created and multiplexed based on the extracted program information. Symbols V2, A2, V3 and A3 denote packets of video and audio data corresponding to programs that will not be recorded. These packets are deleted because they are not necessary at the time of reproduction. Now, an output transport stream shown in FIG. 3B can be obtained from the input transport stream of FIG. 3A.

If there is any other target information packet to be referred to at the time of reproduction, such an information packet may be extracted and output.

The output transport stream from the demultiplexer 30 is input to a recording/reproducing controller 80. The recording/reproducing controller 80 executes processing for the transport stream using a memory 90, and records the input transport stream in the HDD 100.

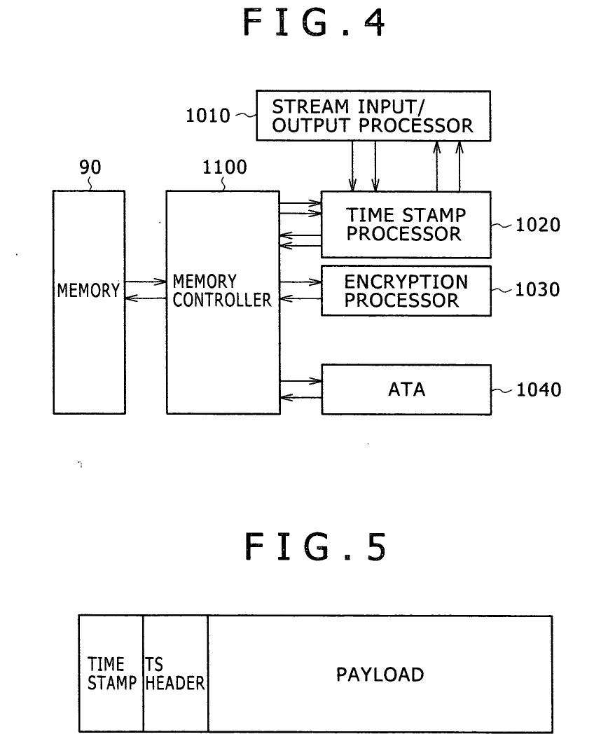

FIG. 4 exemplarily shows a structure of the recording/reproducing controller 80. The input transport stream is input to a time stamp processor 1020 through a stream input/output processor 1010. The time stamp processor 1020 adds time stamp data representing the input time to each packet of the input stream, as shown in FIG. 5.

The reason why the time stamp data is added to the packet is that the recorded data needs to accurately be reproduced in accordance with their inputting timing, when reproducing and outputting the recorded data as a transport stream from the HDD 100. As a result, the transport stream recorded as data is reproduced and output, thereby reproducing the time information that is referred to when decoded by the decoder 40.

The transport stream data having the time stamp added thereto is once stored in the memory 90 through a memory controller 1100.

The transport stream data including the time stamp added thereto is read through the memory controller 1100, and encrypted by an encryption processor 1030. Encryption of the transport stream data is done for the sake of copyright protection. The encrypted transport stream data is stored again in the memory 90 through the memory controller 1100. The encrypted and stored transport stream data is recorded in the HDD 100 through an ATA (AT Attachment) interface 1040 which interfaces with the HDD 100.

When reproducing the data, the transport stream data recorded in the HDD is read through the ATA interface 1040, and stored once in the memory 90 through the memory controller 1100.

The transport stream data stored in the memory 90 is input to the encryption processor 1030 through the memory controller 1100 so as to be decrypted therein, and stored again in the memory 90 through the memory controller 1100.

The decrypted transport stream data stored in the memory 90 is input to the time stamp processor 1020 through the memory controller 1100, and the data (excluding the time stamp therefrom) is output at the time specified in the added time stamp through the stream input/output processor 1010.

As a result, the transport stream can successfully be output at the input timing in accordance with the reproduced transport stream data recorded in the HDD 100. These operations are executed under the control of the controller 120 shown in FIG. 1.

Such a recorded and reproduced transport stream is input to the demultiplexer 30, thereby reproducing the video and audio data in accordance with the above procedures.

In some situations, a graphic screen is superimposed and displayed by reference to an information packet multiplexed into the transport stream.

The above-described operations are controlled by the controller 120 through a bus 160, e.g. a PCI (Peripheral Components Interconnect) bus. This controller 120 operates in accordance with an instruction input from an instruction unit (e.g. a non-illustrated remote controller) through an input section 110 and a program stored in advance in a non-illustrated memory. As shown in FIG. 1, the tuner 20 is controlled by the controller 120 through its own bus 161.

A description will now be made of an operation for reproducing and/or recording an output video signal from a camera 130 (shown in FIG. 1) and an output audio signal from a microphone 140. Note that, in the following description, “photograph data” represents a set of the output video signal of the camera 130 and the output audio signal of the microphone 140.

The photograph data obtained from the camera 130 and the microphone 140 is input to an encoder 150. The encoder 150 encodes the input photograph data, multiplexes the video and audio data and outputs the resultant data. As a result of the encoding of the encoder 150, an MPEG format transport stream (shown in FIGS. 2 and 3) (i.e. like the format that can be reproduced by the tuner 20) can be obtained. The output transport stream of the encoder 150 is input to the demultiplexer 30. When reproducing the data, the encoded photograph data is processed by the demultiplexer 30 in the same manner like the above, and decoded by the decoder 40 thereafter. The audio data is reproduced, while the video signal is displayed by the graphic processor 50. In this case, the OSD is superimposed onto the video signal so as to be displayed, if needed. When recording the data, the photograph data is processed by the recording/reproducing controller 80 in the same manner like the above, and then recorded in the HDD 100.

The recording/reproducing controller 80 can record the transport stream which has been output from the encoder 150 through the demultiplexer 30, and at the same time can also record the transport stream, which has been reproduced by the tuner 20 and extracted by the demultiplexer 30. These two transport streams can be recorded in the HDD 100 in association with each other. Specifically, these two transport streams are: the photograph data, which is obtained by the camera 130 and the microphone 140 and encoded by the encoder 150, and the broadcast signal which is reproduced by the tuner 20.

The controller 120 refers to and analyzes the video and audio data temporarily stored in the memory 90 in the recording process by the recording/reproducing controller 80, extracts distinctive data therefrom, and records data corresponding to the extracted data in the HDD 100 as a management file.

Note that the distinctive data is data representing a distinctive part of the photograph data, and the definition of “distinctive” in this case may have several different ideas. One example of distinctive photograph data is data representing a scene in which one person being photographed suddenly starts movement, suddenly speaks out, or raises his/her voice above a certain level. In this case, the controller 120 determines whether the photographed object suddenly moves, by analyzing a motion vector of a video signal within a predetermined time period, while a video signal is being output from the camera 130, or determines whether the amplitude of the audio signal output from the microphone 140 exceeds a predetermined threshold value stored in a memory (not illustrated) of the controller. Based on this analysis or determination, the controller 120 determines that the data is photograph data.

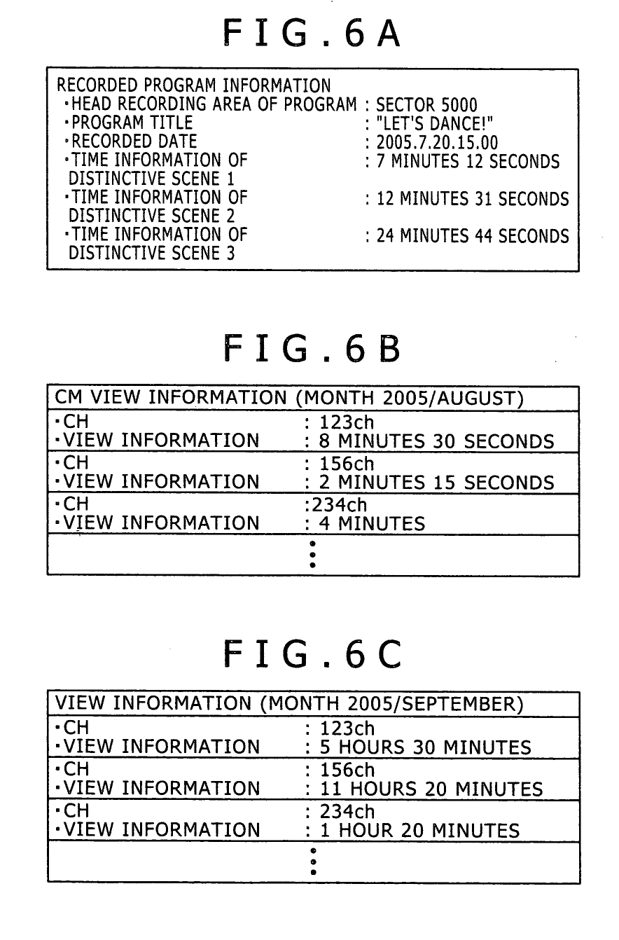

FIGS. 6A to 6C are diagrams each showing a content structure of a management file in this embodiment. The controller 120 issues an instruction to record information regarding the recorded broadcast program (e.g. the head recording area of the program data, the program title, and the date/time) in the management file with a distinctive part recorded in it, as shown in FIG. 6A. Further, the controller 120 issues another instruction to record time information representing the time of the extracted distinctive data part (e.g. information representing the time the distinctive part of the data begins after the program starts).

When reproducing the recorded photograph data from the HDD 100, the recorded program is specified and simultaneously reproduced, and the distinctive part of the photograph data can easily be specified and reproduced, thus resulting in a user-friendly system.

For example, if a child's favorite program is stored and kept long afterwards, he/she can recall a childhood memory in association with a scene of the recorded program, i.e. what he/she watched or how he/she expressed himself/herself about a certain scene of the recorded program. At the same time, the child's parents can not only keep a record of their child, but also be aware of what he/she likes, and they may consider the child's favorite as a good guide to his/her education.

The management file data shown in FIGS. 6A, 6B and 6C may be displayed on a display section 190, resulting in the user-friendly system.

In the above-described embodiment, a program scene is recorded in association with the distinctive part of the photograph data. However, when one scene of a program content is watched, data corresponding to the one scene may be recorded in association with the photograph data.

More particularly, for example, the controller 120 extracts the climax scene (e.g. a bad guy is beaten by the hero) of an animated cartoon, and records the extracted data in association with image data (still image or moving image) representing the facial expression of a child watching the cartoon. As a result, a viewer's reaction on one scene of a predetermined program can be observed.

To extract a scene of a program, the transition from one scene to another may be detected in the unit of pixel based on an inner product operation. Alternatively, a predetermine scene may be extracted based on the average amplitude level of the audio signal level within a predetermined period of time.

Needless to say, the user can select a desired scene extraction method from several methods, if there are many. In such a case, a scene extraction method selector (not illustrated) is provided inside or outside the controller 120. If the user selects a desired extraction method using an operation unit (e.g. a remote controller provided on the information processor), a selection signal representing the user selection is sent to the controller 120. Upon reception of the selection signal, the controller 120 selects the scene extraction method represented by the received selection signal from the plural extraction methods recorded in the memory 90, etc., and extracts a predetermined program scene using the selected extraction method. Hence, the user can choose the method for recording the photograph data from many options, thus providing a user-friendly system.

Note that the above-described predetermined scene of the program may be an ad commercial. In this case, the controller can store information representing whether the user watches the commercial, and can store the facial expression of the user watching the commercial. This embodiment will now be explained with reference to FIG. 6B.

FIG. 6B shows an example of a management file representing the view information representing how long the user watched the commercials ranked in order of time length. The controller determines whether the user watches commercials, based on the image data picked up by the camera 130. In this case, the controller 120 records the user's personal information, such as his/her face, clothes, etc., in the recording section (e.g. the memory 90 or HDD 100), and compares and verifies the image data picked up by the camera 130 with the recorded personal data.

To compare and verify the image data with the personal data, the controller may calculate the percentage of the user's face or body within the entire image area of the TV, etc. If the obtained value as a result of the comparison exceeds a predetermined threshold value, the controller 120 judges that “the user watches the program content or commercials (user views and listens)”. On the other hand, if the obtained value is lower than the predetermined value, the controller 120 judges that “the user does not watch the program content or commercials (user does not view)”. The controller 120 records time information representing the time length the user views the commercials, in the recording section (e.g. the memory 90 or HDD 100).

That is, the controller can easily record information representing how long the user views the commercials. Further, when the controller 120 judges that the “user watches the TV”, view information (representing commercial information in association with the image data obtained by the camera 130) may be recorded. By so doing, the controller 120 can not only judge whether the user watches commercials, but also record information representing the facial expression or physical appearance of the user while watching the commercials. Note that the commercial information may include not only the contents of the ad information, but also the advertiser, the broadcast time zone of the commercial, and the product or actor appearing in the commercial.

Like the above, a process for measuring the audience rating of the program will now be described with reference to FIG. 6C. The controller judges whether the user watches a predetermined program of a predetermined channel according to the above-described judgment method. In such a case, the controller 120 records the image data output from the camera 130 in association with the predetermined program, when “the user watches the TV (user views)”. By so doing, the controller 120 can not only judge whether the user watches the predetermined program, but also record information representing the facial expression or physical appearance of the user while watching the program.

Sometimes, the user may watch only a part of the program, for example, when the user goes to the toilet for a moment or skips the commercials. In such a situation, even if the user watches the program just for a second, the controller judges that the user watches the TV. Thus, to understand the fact whether and how long the user watches the program contents, the controller may judge that “the user truly views the program contents”, only when the controller judges that the user views the program contents continuously for a predetermined period of time, or when the controller judges that the user views the program contents continuously for a predetermined period of time that is longer than a predetermined time length within the total time of the program contents.

For example, the controller judges whether the user views the program contents at intervals of 10 ms (judging at any instantaneous point). If it is judged that the total viewing time is equal to or greater than the half of the total program time, the controller judges that the user views the program (judging the total viewing time).

In this manner, the controller judges whether the user views the program contents in accordance with both the instantaneous viewing points and the total viewing time, resulting in a better understanding of whether and how long the user watches the program contents.

A description will now be made of a process for reproducing the recorded contents using the management file data shown in FIGS. 6A, 6B and 6C. Upon transmission of an instruction signal from a remote controller, etc., the controller 120 refers to the management file data recorded in the recording section (e.g. the memory 90 or HDD 100), and controls the display processing for displaying the referred data in a predetermined display style.

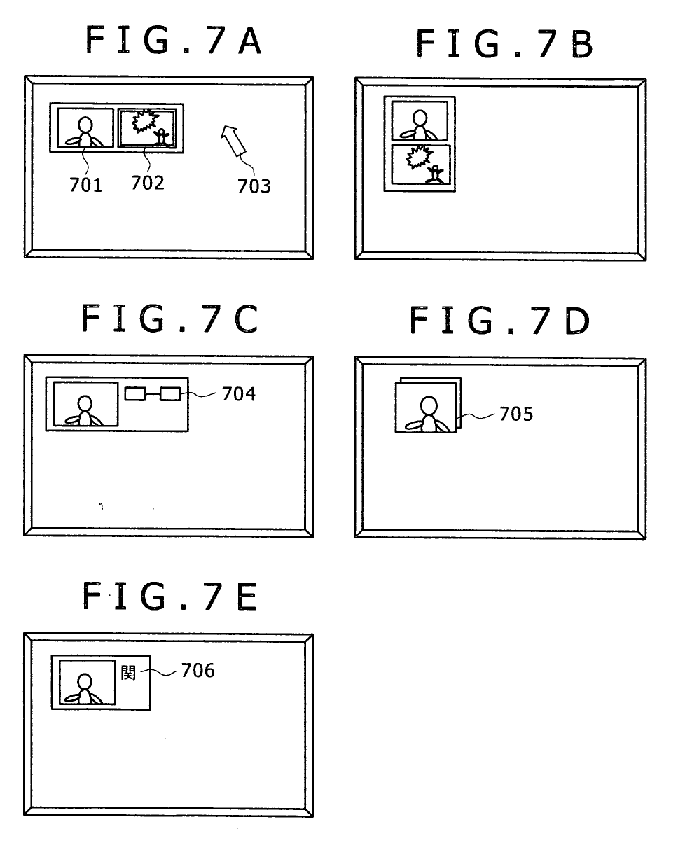

FIGS. 7A, 7B, 7C, 7D and 7E are diagrams each showing an example of a display style, and each exemplarily showing a selection screen displaying a thumbnail image of the user. An image 701 is a part of image data photographed by the camera 103, an image 702 is a part of program data, and an image 703 is an instruction unit, such as a cursor, etc. As shown in FIGS. 7A and 7B, if beginning (or middle or last) parts of the photograph data and program data are displayed in parallel or vertically, the user can easily understand what kind of information is recorded in association with each image.

Such image data may be displayed in any of various display styles. For example, a symbol image 704 represents that some related program contents exist, as show in FIG. 7C. A shadowed image 705 may be provided as shown in FIG. 7D. A letter or character image 706 may be provided as shown in FIG. 7E. In this manner, if the display screen shows information indicating the related program contents, it will ease the burden of system processing. Further, with the symbol image, the display screen can be efficiently used, and can indirectly inform the user that there are the related program contents, thus providing a user-friendly system.

### Second Embodiment

Based on the management file data show in FIGS. 6A to 6E, the program content provider (e.g. the broadcasting station, program network distributor (in the form of Video on Demand) and the contents creator, etc.) can objectively analyze their service, what is good and bad in their program contents. Hence, using such valuable data, the program content provider may improve their business.

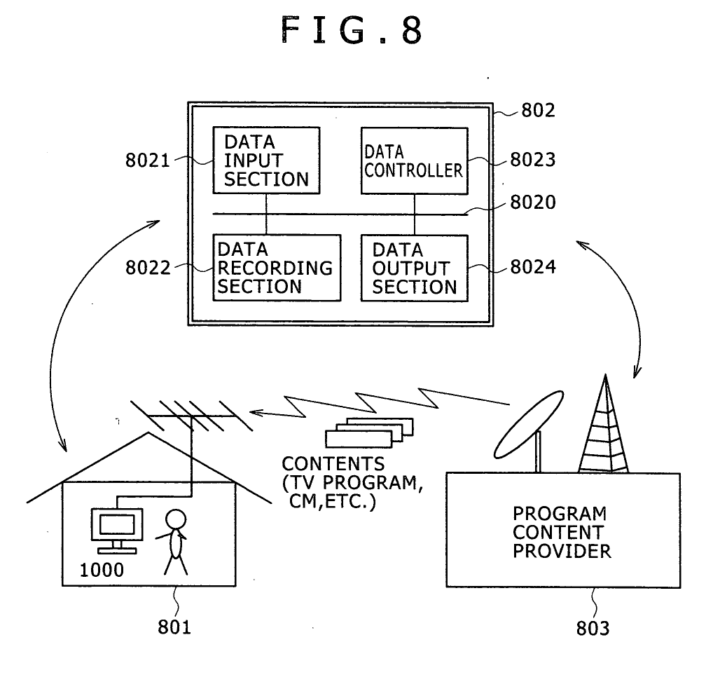

A description will now be made of a service for storing the above-described management file data using the Internet, and for providing the stored data to the program content provider, with reference to FIG. 8.

FIG. 8 is a diagram showing the entire system of the service. The service system includes a house 801, a service center 802 and a program content provider 803. The house 801 has a recording/reproducing device 1000 (illustrated in FIG. 1 and hereinafter referred to as an information processor 1000) which can receive digital broadcast data. It is assumed that the house 801 is a personally owned house, but may be an apartment or an office.

In this embodiment, a TV program and its accompanying commercials are sent from the program content provider 803 to the house.

When the user watches the TV program or commercials, the controller 120 performs the above-described judgment, and records the management file data shown in FIGS. 6A to 6C. Further, the controller 120 sends the recorded management file data to, for example, the video signal output section 60, the audio signal output section 70, or the service center 802 through an output unit prepared only for outputting the management file data.

The service center 802 comprises a data input section 8021, a data recording section 8022, a data controller 8023 and a data sender 8024. Data transmission can be achieved between each section of the service center 802 through a data bus 8020. The service center 802 may be a high-performance and large-capacity personal computer. The service center 802 receives the management file data and its corresponding video data and audio data from the house 801 through the data input section 8021.

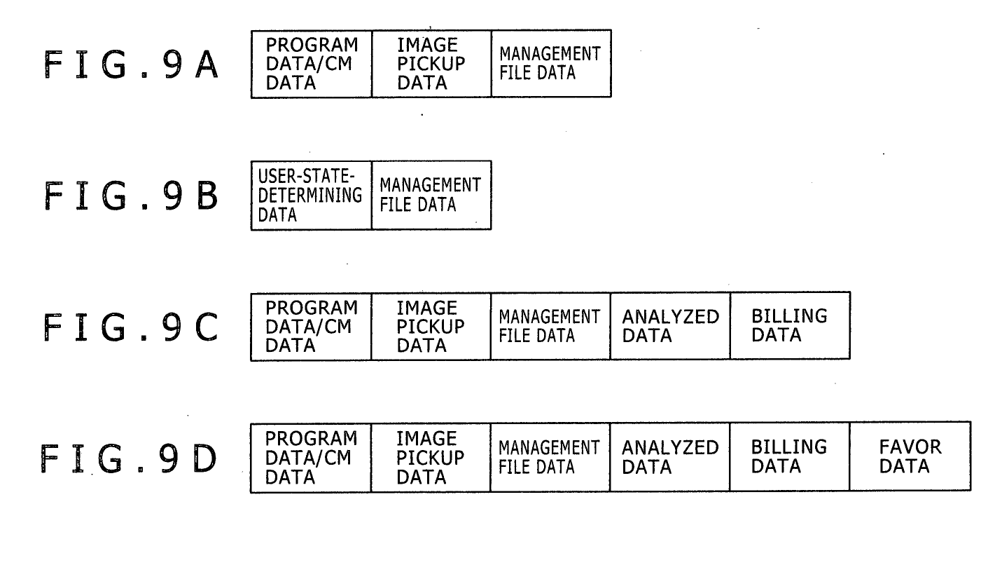

The service center 802 records the management file data received in the data recording section 8022, and sends the recorded management file data, etc. More particularly, when the user watches a predetermined CM or program, the data controller 8023 sends the management file data, its corresponding CM data and program data, the video data and the audio data to the program content provider 803. Specifically, the management file data represents the commercials and the time length the user watches, the video data is input from the camera 130, and the audio data is input from the microphone 140. FIG. 9A shows a data structure of data sent and received among the house 801, the service center 802 and the program content provider 803.

The program content provider 803 each easily acquire data representing the user reactions on the provided service. This data is very useful and may contribute to improvement of the business quality, because the program content provider 803 can analyze the merits and demerits of the provided service based on the facial expression of the user.

In the above-described embodiment, the management file data, the corresponding CM data, the program data and the image pickup signals are all sent. This causes too much a load on the system to transmit or process the large volume of data, and may effect on the performance of the information processor 1000 and may result in too much a burden on the service center 802 receiving such data.

To ease the burden on executing the processing, the information processor 1000 determines whether the user views the broadcast program based on the photograph data sent from the camera 130 and microphone 140, and sends the determined result to the service center 802.

Particularly, the controller 120 of the information processor 1000 analyzes the video data from the camera 130 and the audio data from the microphone 140. If the controller determines that the user often smiles, it judges that the user “has an interest in” a corresponding program content. On the other hand, if the controller determines that the user sometimes leaves his/her seat without any particular facial expressions or changes the channel, it judges that the user “does not have an interest in” the program, and sends the judgment result as user-state-determining data. The user-state-determining data is text data, thus advantageously handling only a small amount of data. FIG. 9B shows a data structure of data sent and received among the house 801, the service center 802 and the program content provider 803.

As described above, the management file data and the user-state-determining data are sent, thereby tremendously reducing the transmission load and the processing load as compared to the case where the management file data and its corresponding CM data, program data and the image pickup signals are all sent together. The same effect can be expected on the side of the service center 802 receiving such data.

To improve the processing efficiency, the service center 802 can send the management file data (from the house 801) as it is to the program content provider 803. To improve the value added to the service center 802, the service center 802 may edit the received management file data so that the data is useful for the program content provider 803.

For example, the service center 802 analyzes the user preference tendency, etc. based on the management file data collected from many houses 801, adds the analyzed data to the management file data, and sends the data.

In this case, the data controller 8023 analyzes the user preference tendency based on the received management file data, and records the analyzed data in the data recording section 8022. The data controller 8023 sends the recorded analyzed data and the management file data to the program content provider 803 through the data sender 8024, in response to a transmission instruction.

While sending the analyzed data, the service center 802 adds data representing the cost for creating the analyzed data as billing data to the analyzed data, and sends the analyzed data having the billing data added thereto. The service center 802 can execute the billing process with high efficiency, because the analyzed data (product) and the billing data (cost) are sent together. The program content provider 803 can easily understand the relationship between the product and the cost, because the analyzed data (product) and the billing data (cost) are sent together. FIG. 9C shows a data structure of such data to be sent and received between the two.

If the program content provider 803 sends an evaluation of the analyzed data (product) to the service center 802, the service center 802 can easily understand the evaluation of the service (the analysis of the user tendency to view the program), thus contributing to the business improvement.

However, some users may not like to show their appearance (while watching TV) to any third party, and do not want the third party to use the appearance data afterwards. To give an incentive to such users to provide their view information, the service center 802 or the program content provider 803 offers some kind of special favor to those users who have provided the management file data shown in FIGS. 6A to 6D. In this case, the favor may be some special information, cash, an electrical appliance, a car, predetermined points. The favor information is sent to the house 801 from the service center 802 or program content provider 803. In this case, the controller 120 of the information processor 1000, which has received the favor data and is installed in the house 801, displays the received favor data on the display/reproducing section 190 to inform the data to the user. FIG. 9D shows a data structure of such data to be sent and received therebetween.

As described above, the user may enjoy various favors in change for sending his/her view information (their appearance, facial expression, etc.) while viewing TV to the service center 802, etc.

If a predetermined coupon is given as the favor, it is assumed that the user needs to earn, for example, ten coupons to get a desired product. Thus, the controller 120 records the received favor data in the recording section (e.g. the memory 90 or HDD 100) as history information of the favor data. In this manner, the processing efficiency is improved, by executing the recording process depending on the contents of the favor data.

According to the above-described example of the service provided by the service center 802, the user viewing tendency is analyzed and provided in response to the request from the program content provider 803. As long as the management file data from the house 801 is referred to, the method is not limited to the above.

If an instruction for sending information is automatically sent from the information processor 1000 to the service center 802 after the management file data is stored, the latest information is sent to the service center 802. Thus, the latest information is always given to the service provider for providing services using the service center 802.

Needless to say, after the management file data is collected for a predetermined period of time, the collected data is together sent to the service center 802. In this case, the controller 120 of the information processor 1000 executes a process for sending the collected data based on transmission schedule data recorded in the recording section (e.g. the memory 90 or HDD 100).

According to the above example, the information from the information processor 1000 of the user is received by the service provider having the service center 802 installed therein, and then the service provider sends the received information to the program content provider 803. However, it is not limited to this. For example, the program content provider 803 may directly receive the data and use the received data. In such a case, the data is forwarded from the information processor 1000 directly to the program content provider 803 without going through the service provider.

In this case, data specifying the destination is included in the received data for receiving the program contents. The information processor 1000 acquires the destination-specifying data from a broadcast wave, etc., and the controller 120 determines the destination. The received data may be sent through the Internet, or a telephone line using a modem.

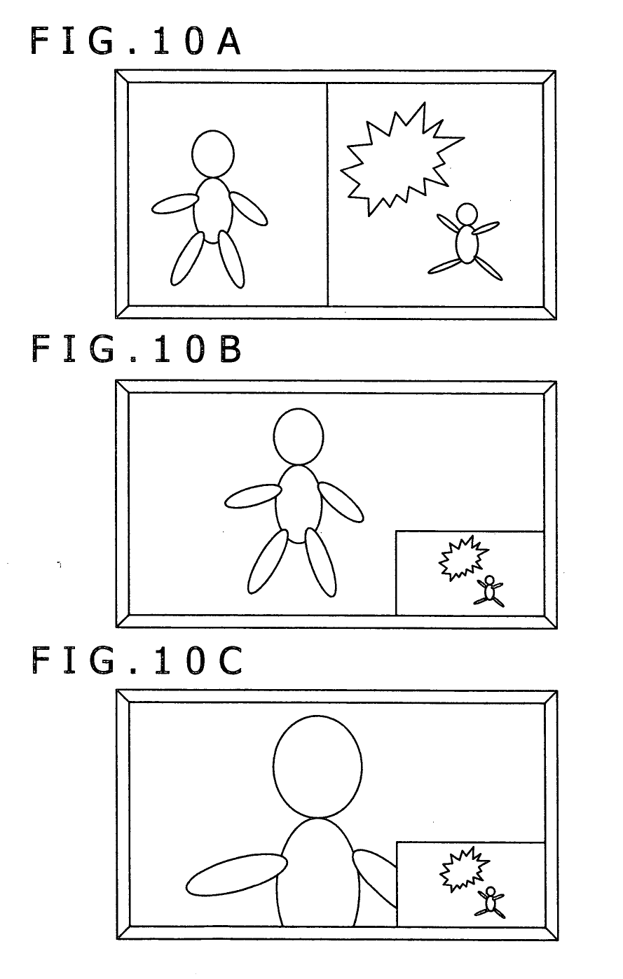

The demultiplexer 30 and the decoder 40 both have the ability to simultaneously execute two transport streams. For example, the demultiplexer and the decoder can show two parallel displays as shown in FIGS. 10A to 10C. In this case, the main display screen shows the photograph data, while the sub display screen shows the broadcast program.

Hence, for example, a child's growth record can be kept in an attractive manner that is different from the usual recording system for recording the child using a video recorder.

In the above embodiments, the photograph data and the broadcast program are displayed simply in the style of two display screens, but the display style is not limited to this. Because the distinctive part of the photograph data can be specified, some kind of display processing may be operated for the specified distinctive data. More particularly, if the distinctive part is displayed, the reproduced photograph data is enlarged so that the facial expression of the displayed person can clearly be shown, as shown in FIG. 10C.

In the above embodiments, the distinctive scene is extracted from the data temporarily stored in the memory 90 connected to the recording/reproducing controller 80. However, the distinctive scene may be extracted from the processing contents at the time the analog signal is encoded by the encoder 150. In this case as well, the distinctive part of the photograph data can be extracted, and the same effect can undoubtedly be obtained.

In the above embodiments, it is assumed that the data is shown in the form of two parallel displays, but the display style is not limited to this. For example, the image pickup data from the camera 130 and the broadcast image from the tuner 20 may be incorporated and displayed together. For example, when a child is watching a cartoon program, the hero of the cartoon can be replaced by the child's face. When, the user inputs an instruction signal for instructing to incorporate the pickup image from the camera 130 and the broadcast image from the tuner 20, data (hereinafter referred to as camera input face data) representing the child's face is extracted from image data representing the child image picked up by the camera 130, and then the extracted data is stored. At the same time, data (hereinafter referred to as broadcast input face data) regarding the face of the hero is extracted from the video data of the recorded cartoon program. In this case, data representing the display position of the hero and his/her face is stored in advance, and the broadcast input face data is extracted and deleted from the positional data when the hero just appears. Then, the camera input face data is displayed in the position of the deleted part.

As explained above, the image pickup data from the camera 130 and the broadcast video data from the tuner 20 can be incorporated together, thus providing a user-friendly system. For example, when the user watches a golf instruction program, the user can display himself/herself practicing golf in front of the TV in real time. In this case, if the user displays himself/herself near the golf instructor in the broadcast image, the user may feel as if he/she were really practicing golf. Further, if the user can keep the history record of the practice image data, he/she can desirably go over the lesson.

The camera input face data and the broadcast input face data can be recorded in association with each other like the management file data of FIGS. 6A to 6C. As a result, the corresponding data can easily and efficiently be processed in the same processing afterwards.

The photograph data may be processed only in accordance with a predetermined instruction. In other words, the distinctive part of the photograph data is not necessarily extracted in response to an instruction input to the controller 120 from a non-illustrated remote controller, for example.

Hence, the recorded photograph data itself can simply be reproduced and viewed without executing the above-described operation, when reproducing the photograph data, for example. Further, when recording the photograph data, the distinctive part may not be extracted therefrom, and thus there is no need to create the management file recording the distinctive part. As a result, the processing can be executed with high efficiency, and thus providing a user-friendly system.

As explained above, if the photographed scenes and programs are recorded over and over in the HDD 100 to capacity, no more data can be recorded therein. In such a case, an output section 800 shown in FIG. 1 outputs the recorded photographed scenes, the recorded programs and a management file corresponding to the recorded data in association with each other, to an external storage medium 200. In this case, upon reception of an instruction signal for recording the data, the controller 120 sends an instruction for recording the data to the external storage medium. As a result, important data can be securely stored.

In the above explanation, the camera 130 and the microphone 140 are incorporated in the digital broadcast receiving/recording/reproducing device. However, the present invention is not limited to this structure. For example, the input section of the encoder may be connected only to the video signal input section and the audio signal input section. More particularly, for example, the video output section and the audio output section of a commercially available video camera may be connected thereto. The rest of the configuration is the same as that shown in FIG. 1. If the controller 120 extracts the distinctive part of the photograph data encoded by the encoder 150, the same processing can be carried out as explained above with reference to FIG. 1.

According to the above-described configuration, there is no need to prepare the camera 130 and the microphone 140 in advance, the system can be made simple, thereby reducing the scale of the circuit scale and the production cost.

It is assumed that general-purpose terminal connections are used as the video signal input section and the audio signal input section, from standpoints of cost and connection. In this case, any video/audio signal output unit can be used as long as it has a connectable terminal. That is, a signal reproducing a commercially available movie title can be input with using a connected DVD (Digital Versatile Disc) reproducer.

However, in general, the recording of such a commercially available movie title is prohibited for the sake of copyright protection. In this manner, the video signal that is prohibited from being recorded by another device includes information representing the prohibition. In FIGS. 10A to 10C, information representing the prohibition is extracted by the encoder 150 or the controller 120. If extracted, i.e. recording is prohibited, it is controlled that the data is not recorded in the HDD 100. As a result, the copyright protection can be practiced.

In the above-described embodiments, the analog video and audio signals are input respectively from the video signal input section and the audio signal input section, and are encoded by the encoder 150. However, instead of such signals, the signals may be multiplexed and may be input in the form of an originally multiplexed stream. In this case, there is provided a stream input section for inputting the steam in which the video and audio signals are multiplexed. The stream input from the stream input section is input directly to the demultiplexer 30. The operations afterwards are the same as those described above.

As a result, the encoder 150 is not necessarily included in the processor, thus further simplifying the system configuration and reducing the cost.

### Third Embodiment

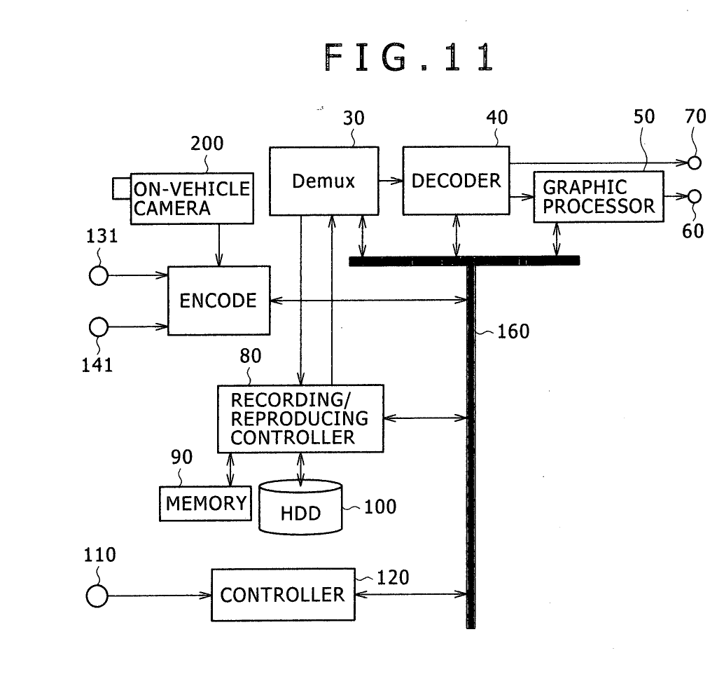

In the above-described embodiments, the digital broadcast receiver, the camera and the microphone are incorporated together. According to a third embodiment of the present invention, however, two cameras may be used, as shown in FIG. 11. FIG. 11 shows a system configuration for recording a video image from an on-vehicle camera and a video and audio signals taken by a household video camera, in association with each other.

In this embodiment, a numerical symbol 200 denotes a camera installed in or on a vehicle, and may photograph the front view from the vehicle, for example. In the process executed by the recording/reproducing processor 80 for recording/reproducing a video signal from the on-vehicle camera 200, the controller 120 may determine that a predetermined distinctive part is included in the video data. In this case, the controller 120 records an input video signal from the video signal input section 131 connected to a non-illustrated video camera and an input audio signal from the audio signal input section 140, together with the video image of the camera 200. More particularly, while the vehicle is traveling, if the camera photographs, for example, a sign showing a white letter in the green background, the controller 120 records the input video signal of the camera 130 taking a photograph of the inside of the vehicle and the input audio signal of the microphone 140, together with the video image of the camera 200. As a result of this, the scenes of the car trip can efficiently be recorded, and thus providing a user-friendly system.

In this above-described embodiments, the video camera is connected to the video signal input section and the audio signal input section. However, the video signal and the audio signal are not necessarily transmitted by wire, and may be transmitted by a radio system using infrared rays or radio waves In this case, the user can easily use the system without the need of the troublesome wiring.

One example of the above-described information processor is a TV, a cell phone, a PDA or a PC with an image pickup system. However, the present invention is not limited to this, and can be realized by any other device that has an image pickup system.

The present invention is not to be limited to the above-described embodiments, and various changes and modifications can be made thereto without departing from the spirit and scope of the invention, and any combination of the above can be made.

What is claimed is:

1. An information processor comprising:
a receiver that receives a broadcast signal;
a demodulator that demodulates the broadcast signal received by the receiver;
a video input section that inputs a video signal;
an audio input section that inputs an audio signal;
an encoder that encodes the video signal input from the video input section and the audio signal input from the audio input section;
an output section that multiplexes the video and audio signals encoded by the encoder, and outputs a multiplexed signal;
a recording section that records an output signal of the demodulator and an output signal of the output section; and
a controller that extracts data representing a distinctive part of the video signal input from the video input section or a distinctive part of the audio signal input from the audio input section in accordance with a predetermined standard, and records management file data representing a relation between the data representing the extracted distinctive part and the output signal from the demodulator in the recording section.

2. The information processor according to claim 1,
wherein the predetermined standard is based on a change in the data input by the video input section or the audio input section within a predetermined period of time.

3. The information processor according to claim 1, comprising a management file data output section that outputs the management file data.

4. The information processor according to claim 1,
wherein the controller displays the broadcast signal received by the receiver and the video signal input from the video input section.

5. The information processor according to claim 1,
wherein the controller extracts the distinctive part using processing information for encoding the video signal and the audio signal in the encoder.

6. The information processor according to claim 1,
wherein the controller selects whether to process an output stream of the encoder and an output stream of the encoder in association with each other.

7. The information processor according to claim 1,
wherein the controller controls the recording section to record data based on copy controlling information, included in the input video signal or the input audio signal and regarding whether the data can be copied.

8. The information processor according to claim 1,
wherein the video input section includes a camera, and the audio input section includes a microphone.

9. An information processor comprising:
a first and second video input sections each of which inputs a video signal;
a first and second audio input sections each of which inputs an audio signal;
a recording section that records the video and audio signals;
an output section that outputs the video and audio signals recorded in the recording section; and
a controller that creates management data for processing the video and audio signals respectively from the first video input section and the first audio input section, in association with the video and audio signals respectively from the second video input section and the second audio input section, and controls the output section to output the video signals and the audio signals recorded in the recording section using the management data.

10. An information processor comprising:
a first and second video input sections each of which inputs a video signal;
a first and second audio input sections each of which inputs an audio signal;
a recording section that records the video and audio signals;
a display section that displays the video and audio signals recorded in the recording section; and
a controller that controls the display section to display data representing that the video signal from the first video input section or the audio signal from the first audio input section is processed in association with the video signal from the second video input section or the audio signal from the second audio input section, when displaying the video and audio signals using the management data for processing the video and audio signals respectively from the first video input section and the first audio input section in association with the video and audio signals respectively from the second video input section and the second audio input section.

11. An information processing method comprising the steps of:
receiving a first video or audio signal, a second video or audio signal and management data for processing the first video or audio signal in association with the second video signal or audio signal, the management data being created for processing distinctive data of the first video and audio signals in association with the second video and audio signals corresponding to the distinctive data;
analyzing the received management data; and
outputting the first video or audio signal, the second video or audio signal together with data representing a result of the analyzing step.

12. The information processing method according to claim 11,
wherein the step of analyzing the received management data is performed based on data regarding whether a user views and listens to the first video and audio signals.

13. An information processing method comprising the steps of:
receiving a broadcast program, a pickup image, and management data for processing the broadcast program and the pickup image in association with each other;
analyzing a user state of whether a user views the broadcast program based on the received management data; and
outputting data representing a result of the analyzing step.

14. The information processing method according to claim 11, further comprising the step of:
when outputting data representing the analyzed result, adding favor data including billing data regarding a billing process and favor information regarding a favor to be given to a user, to the data to be output.
